(19) United States
(12) Patent Application Publication
(10) Pub. No.: US 2008/0185336 A1
(43) Pub. Date: Aug. 7, 2008

(54) Process for solid-state methane fermentation of biomass materials and fermentation apparatus system therefor

(76) Inventors: Takaaki Maekawa, Inashiki-shi (JP); Takeshi Paul Owa, Kure-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,957

(22) Filed: Jan. 17, 2008

(30) Foreign Application Priority Data
Feb. 5, 2007 (JP) 2007-26206

(51) Int. Cl. C02F 11/04

(52) U.S. Cl. 210/603; 210/255

(57) ABSTRACT

A process for producing a biogas by solid-state fermentation of a solid biomass material which comprises the steps of:

(1) pelletizing the biomass material into pellets;
(2) introducing the pellets into an acid fermentation zone;
(3) subjecting the biomass material in the pellets to solid-state acid fermentation under facultative anaerobic conditions or under semi-aerobic conditions kept in an oxygen concentration of 0.01% to 5.0%;
(4) densifying the pellets by compression to remove the oxygen from among the particles of the biomass material;
(5) transferring the densified pellets into a methane fermentation zone; and
(6) subjecting the biomass material in the densified pellets to methane fermentation in the methane fermentation zone under anaerobic conditions, and
an apparatus system for producing a biogas by solid-state fermentation of a solid biomass material which comprises: an acid fermentation tank (7) having a means for pelletization (4) of the solid biomass material and an air inlet (25) with a movable valve; and a methane fermentation tank (11) having a pellet compressing means (12) connected to the acid fermentation tank (11) through a movable valve (9) for separation.

### BACKGROUND OF THE INVENTION

The present invention relates to a process for acid fermentation and methane fermentation of a solid biomass material without using water as well as a fermentation apparatus system which is to use the process.

A wet methane fermentation process wherein a solid biomass in mixture with water is subjected to anaerobic fermentation is widely put into practice as a method for methane fermentation of biomass under an anaerobic condition.

In such wet methane fermentation process, however, there is a drawback that cost for facilities becomes higher as a fermentation tank of approximately 15 to 20 volumes per volume of the starting biomass material is necessitated, thereby increasing the capacity of the facilities.

A dry methane fermentation process wherein a solid biomass material is subjected to methane fermentation by the aid of anaerobic bacteria is thus proposed for removing such drawback. According to this method, the capacity of the fermentation tank necessary for treating 1 volume of the starting material is approximately 1.5 times so that it is possible to minimize the apparatus to a certain degree. However, there is also a drawback such that it takes a long period of time to evacuate air existing in the starting solid biomass material so as to keep an anaerobic condition necessary for methane fermentation. In case garbage or waste food residue rich in moisture is coexistent in the solid biomass material, facultative anaerobic bacteria propagate themselves within a short period of time while oxygen in the air existing in the solid material is consumed, so that decomposition by the aid of the facultative anaerobic bacteria is promptly accelerated to permit production of a great deal of organic acids, thus shifting pH to an acidic range. For these reasons, propagation of methanogen growing within an alkaline range is inhibited or stopped with the result that the formation of a biogas will take at least about one year.

With respect to a dry methane fermentation process, the prior art includes a process for efficiently generating methane wherein a device is made for the composition of biomass material and the reaction conditions comprising mixing a solid side-material with a granular or sludge-like organic waste material, in the course of methane fermentation of a biomass starting material under anaerobic conditions, to prepare a waste mixture possessing air-permeability and fluidity, and thereafter bringing the mixture to an anaerobic fermentation (cf. JP11-309493A), a method wherein the C/N ratio of an organic waste material is adjusted to 20 to 250 (cf. JP2001-347247A), a method wherein an organic waste material is mixed with an inorganic porous material and the mixture is introduced into a methane fermentation tank (cf. JP2002-320949A) and a method wherein an organic waste material is mixed with a carbide and the mixture is subjected to methane fermentation (cf. JP2005-230624A).

In all of these process and methods wherein a biomass starting material is mixed with a separate side-material and then the fermentation conditions is adjusted, however, expense for acquiring the side-material and addition of the mixing step could not escape increase of cost. In addition, it was difficult to carry out completely control of the facultative anaerobic conditions or semi-aerobic conditions prior to conducting the methane fermentation and also control of absolute anaerobic conditions at the time of methane fermentation.

On the other hand, also known is the so-called two-phase type solid-state methane fermentation process wherein photosynthesis bacteria are cultured under an aerobic condition in an acid fermentation tank and the reaction in a methane fermentation tank under an anaerobic condition is promoted by utilizing the heat generated during the acid fermentation tank thereby generating methane efficiently (cf. JP2005-81182A). In the dry-process, the two-phase solid-state methane fermentation process is preferred due to the moderate controllability of the oxygen concentration in the step of acid fermentation and the possibility of keeping the absolutely anaerobic conditions in the step of solid-state methane fermentation. In the aforementioned method wherein the aerobic condition and the anaerobic condition are jointly used, it is difficult to set a diametrically opposite conditions so that it is not realized hitherto.

### SUMMARY OF THE INVENTION

The present invention has been completed with an object to provide, in efficiently conducting methane formation by a two-phase solid-state methane fermentation process, a method for the generation of methane with high efficiency by controlling the aerobic conditions during the acid fermentation and controlling the anaerobic conditions during the methane fermentation without addition of any extraneous materials to the starting biomass materials.

As a result of the extensive investigations for developing a process for producing methane efficiently at a low cost in the two-phase solid-state methane fermentation, it has now been found that the above object can be achieved by feeding a crushed biomass material shaped into a pelletized form to an acid fermentation zone into which air has been introduced, subjecting the biomass material in the zone to acid fermentation under facultative anaerobic conditions or semi-aerobic conditions, compressing the pellets to eliminate a gas containing a very small amount of oxygen and shifting the biomass pellets to a methane fermentation zone where the biomass pellets are compressed under anaerobic conditions and subjected to methane fermentation while removing a gas containing a very small amount of oxygen. The present invention has been completed on the basis of the above finding.

In accordance with the present invention, there is provided a process for producing a biogas by solid-state fermentation of a solid biomass material which comprises the steps of:

(1) pelletizing the biomass material into pellets;
(2) introducing the pellets into an acid fermentation zone;
(3) subjecting the biomass material in the pellets to solid-state acid fermentation under facultative anaerobic conditions or under semi-aerobic conditions kept in an oxygen concentration of 0.01% to 5.0%;
(4) densifying the pellets by compression to remove the oxygen from among the particles of the biomass material;
(5) transferring the densified pellets into a methane fermentation zone; and
(6) subjecting the biomass material in the densified pellets to methane fermentation in the methane fermentation zone under anaerobic conditions, and an apparatus system for producing a biogas by solid-state fermentation of a solid biomass material which comprises: an acid fermentation tank having a means for pelletization of the solid biomass material and an air inlet with a movable valve; and a methane fermentation tank having a pellet compressing means connected to the acid fermentation tank through a movable valve for separation.

In the aforesaid acid fermentation zone, the solid biomass material shaped into pellets under facultative anaerobic conditions or semi-aerobic conditions is used for adjusting the partial pressure of oxygen in the zone lest the temperature should be raised due to occurrence of excessive acid fermentation.

### BRIEF DESCRIPTION OF THE DRAWINGS

FIG. 1 is a flow chart showing an example of the process of the present invention.

FIG. 2 is a schematic side view showing the apparatus system of the present invention.

FIG. 3 is a graph showing the difference in the biogas evolution in the lapse of time with the 3 kinds of the pellets prepared in Reference Example 1.

FIG. 4 is a graph showing the difference in the biogas evolution in the lapse of time with the 3 kinds of the pellets prepared in Reference Example 2.

FIG. 5 is a graph showing the relation between the cumulative amount of biogas evolution and the concentration of methane obtained in Reference Example 3.

### DETAILED DESCRIPTION OF THE PREFERRED EMBODIMENTS

Next, the present invention will now be illustrated by making reference to the annexed drawings.

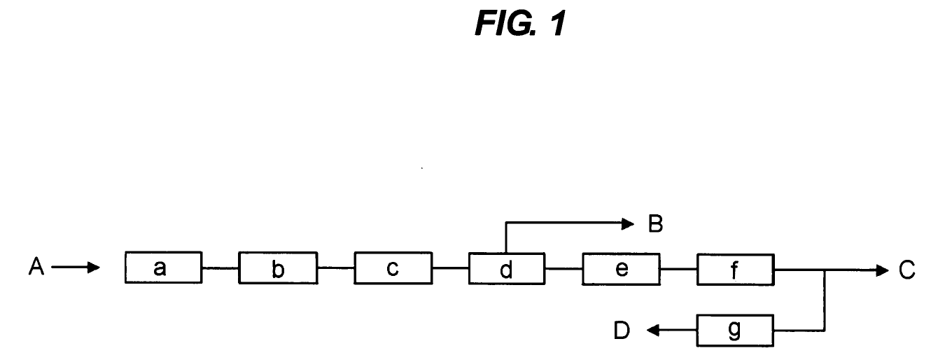

FIG. 1 is a flow chart showing an example of the process of the present invention. This process consists of a coarsely pulverizing step (a), a pelletizing step (b), an acid fermentation step (c), a methane fermentation step (d), a fermentation residue-recovering step (e), a secondary pelletizing step (f) and an energy-producing step (g). A starting biomass material (A) is supplied to the step (a) and treated through the respective steps. Finally, the treated material is exhausted as a combustion residue (D). In the course of the steps, a biogas (B) is formed in the step (d) while a pelletized solid fuel (c) is obtained in the step (f).

As the starting biomass material to be supplied to the step (a), any of the materials utilized for starting materials for methane fermentation can be used which are selected from ordinary organic waste materials of animal or plant origin hitherto used as fermentation materials. Illustrative of such materials are, for example, agricultural wastes such as straw and dry grass, grime of a purified water tank, sewage grime, food wastes, forestry wastes such as lumbering materials and thinning materials, livestock excrements, fishery grime, old papers, and excrements. Among these, what contains a large amount of water, such as grimes and excrements is dried and solidified before use.

These materials are coarsely crushed to have a size not exceeding 100 mm in the step (a) and then pelletized in the step (b) where slaked lime or quick lime can be added, if necessary, in an amount of about 0.001 to 5% based on the mass of the starting materials. In the step (b), the materials are pelletized by way of a double-screw extruder, a piston pressure feeder or the like under pressure of at least 0.5 MPa or, usually, in the range of 0.5 to 80 MPa through a die having a diameter of 7 to 100 mm. The slaked lime or quick lime is added to facilitate adjustment of alkalinity of the biomass material in the methane fermentation subsequent to the acid fermentation.

It is preferable to remove metallic tableware and cooking tools such as a piece of kitchen knives, forks, spoons by the aid of a ultra-permanent magnet or the like, which may be existent in the material prior to crushing.

In the pelletizing step (c) carried out for degassing the air contained in the starting biomass material, it is necessary that since the shaping condition for pelletizing varies according to the water or moisture content of the material, the size of diameter of the die has to be selected to obtain a proper shaping condition. It is preferable to conduct the pelletizing step at a low water content of not more than 40% wet basis.

By the term “% wet basis” is meant a percentage ratio (%) at room temperature under normal pressure of a total of a dry mass of the solid content contained in the biomass material and the water content to the water content.

The acid fermentation step (c) and the methane fermentation step (d) are carried out under the same reaction conditions as adopted in the known methane fermentation; i.e. the step (c) is carried out usually under an anaerobic condition or a semi-aerobic condition kept at 0.01 to 5.0% oxygen concentration while the step (d) is carried out under the absolute anaerobic condition. In the conventional solid-state methane fermentation, a biogas predominantly containing methane is formed but a residue remaining after the methane fermentation contains ammonia and undigested organic acids such as butyric acid, propionic acid and the like and emits an intense bad smell so that the carbonized product obtained after the carbonizing treatment cannot be used beneficially. The residue obtained in the process of the present invention is free from such bad smell and is subjected to a secondary pelletizing treatment in the step (f) where the resultant pellets can be used beneficially as solid fuel pellets.

In the foregoing steps (c) and (d), the yield of the biogas and the velocity of the biogas generation are influenced by the particular oxygen partial pressures so that establishment of a pressure difference is necessary between these steps. This pressure difference is maintained by the action of a bulkhead provided between both steps and a movable valve mounted to the bulkhead in such a manner that the valve is closed always except in the case of the pellets being removed. The concentration of methane in the acid fermentation step is then measured and the movable valve is properly opened or closed to adjust the difference in pressure. In this case, it is preferable to set the oxygen partial pressure within the range of 1 to 5000 Pa in the acid fermentation zone and within the range of 0.1 to 1.0 Pa in the methane fermentation zone.

In the step (d), it is necessary to compress the starting pelletized material so as to leave no void spaces in the biomass particles since metabolism of methanogen, which is one of the absolutely facultative anaerobic bacteria, is significantly influenced by existence of even a very small amount of oxygen. This can be attained by using a compressing mechanism of a press type under a pressure of 0.5 to 10 MPa. In this case, it is important to secure air-tightness between the movable portion of a piston of the press and the upper portion of the fermentation tank so that a sealing of a liquid-sealed type or a labyrinth ring type is preferably applied to enable tolerating the gas pressure of max. 3000 mm Aq. However, considerable decrease in the yield of methane is not recognized in the event the sealing is not applied. If desired, the sealing may be omitted. The increased bulk density of the pellets after compression-densification should be in the range from 920 to 1360 kg/m³.

It is adequate that the water content of the biomass material in the step (c) is about 70% wet basis and that of the biomass material in the step (d) is about 80% wet basis, in these steps, therefore, it is preferred to adjust the water content respectively. It is preferable that evaporated water generated in the course of drying the methane fermentation residue is recovered and used as the supplying water in this case. The supply of water in the step (d) may be carried out by recycling water oozed out from the slurry generated in the step (d).

Disposal of the residue in the methane solid-state fermentation is a very important matter for accomplishment of the so-called co-generation system which means concurrent production of heat energy and electric power since the residue can be used as a fuel for external combustion engines as a power generator. In case where absolutely no incombustible foreign material is contained in the biomass material, the residue in the step (e) is pelletized after drying and the resultant pellets can be utilized as a solid fuel for external combustion engines for power supply.

However, it is usually unavoidable that foreign materials originated from fossil fuel are contained in the biomass material. In general, harmful substances such as dioxins have to be thermally decomposed at a temperature of 800° C. or higher in the event the product is utilized as energy source. According to the process of the present invention, however, the fermentation residue from the step (d) is recovered in the step (e), subjected to the secondary pelletization, and addition of superheated steam at a high temperature under a low pressure (600° C., about 0.2 MPa) to the resultant pellets and then the pellets are subjected to thermal decomposition reaction at above 800° C. by utilizing biogas thereby producing a synthesis gas of high calories. A residue formed in this step is burnt in the step (g).

In case a thermal decomposition reaction furnace employing a booster of biogas combustion is used or a co-generation system due to an external combustion engine is set up as an annex, it is advantageous that a water disposal step is unnecessary for the two-phase solid-state methane fermentation apparatus system.

The combustion residues formed in the step (g), i.e. the ashes include, though dependent on the contents of incombustible inorganic matters in the starting biomass material, useful ones and useless ones. Household wastes such as garbage and waste foods as properly fractionated are in many cases reusable and useful but other useless ones find no other way of disposal than the use as a land filling material.

In case of using the two-phase solid-state methane fermentation apparatus system, it is necessary to experimentally select the volume ratio between the acid fermentation tank used in the step (c) and the methane fermentation tank used in the step (d). In case the amount of biogas is varied depending on the apparent density and water content of the biomass material in the apparent density of the starting material by pelletizing, however, it is experimentally confirmed that if the water content is maintained at about 70% wet basis, the generation of the biogas becomes slow to lower the amount of biogas generated per unit mass.

In the process of the present invention, controlling the water content of the biomass material in the step (c) to about 70% wet basis by maintaining the oxygen concentration at a certain level thus enabled the acid fermentation accompanying an exothermic reaction with the aid of metabolism of facultative anaerobic bacteria. In case the step (c) is carried out for a long period of time, however, there may be the case wherein the methane fermentation in the step (d) is inhibited as the amount of organic acids becomes larger depending on the sort of the biomass material. Accordingly, it is preferable that the step (c) is limited to a range within 10 to 30 days. Control of such reaction time can be carried out while monitoring the oxygen concentration and the reaction temperature either by adjusting the oxygen concentration with an RO membrane or PSA or by varying the amount of slake lime or quick lime added in the step (a).

As it takes about 200 days for the concentration of methane in the step (d) become a steady state, it is preferred that the step (d) is continued at least 200 days. Since the water content of the starting biomass material is preferably about 80% wet basis, a slurry liquid recovered in this step is returned and sprayed to maintain the water content at about 80% wet basis. Particularly preferable water content of the biomass material is 80 to 85% wet basis.

In the process of the present invention, if desired, recovery of a residue of the methane fermentation followed by the step (d) is carried out and the residue is pelletized after drying to manufacture a solid fuel [the step (e)]. Further if desired in the process of the present invention, the solid fuel obtained in the step (e) is heated with super heated steam and further heated with the biogas obtained in the step (d) up to at least 800° C. to produce a thermally decomposed gas.

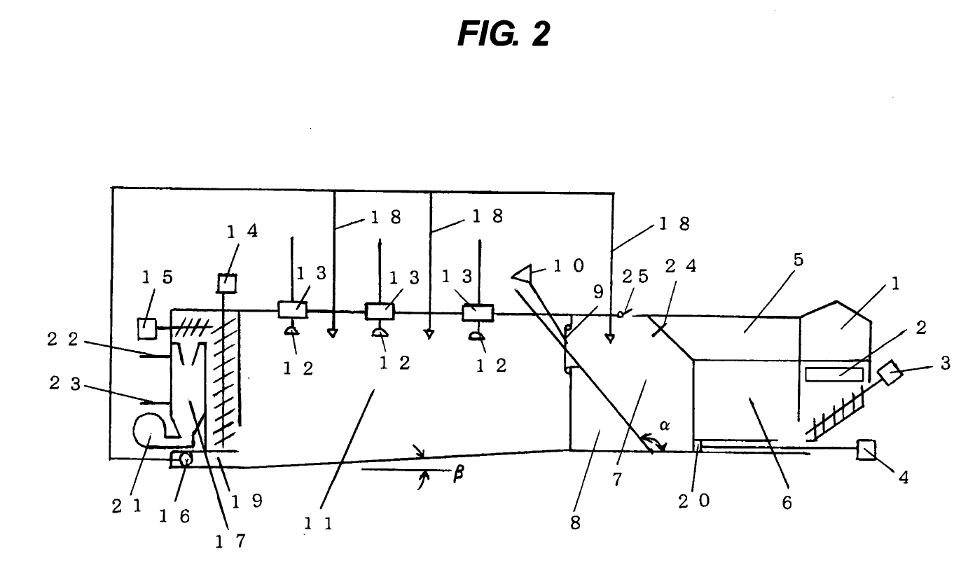

The apparatus system of the present invention will now be illustrated by way of the drawings. FIG. 2 is a schematic side view showing the apparatus system of the present invention.

In this drawing, a solid biomass material from a feeding pit 1 is coarsely pulverized at a pulverizer 2 and pushed by a downwardly pushing screw conveyer 3 into an extruder 4 driven by the drive-controlling unit 5 whereby the biomass material is pelletized. The material is allowed to pass through a preparatory chamber 6 and pelletized through a die 20 and thereafter supplied to an acid fermentation tank 7 having an air inlet 25 with a movable valve. In a heat medium reservoir room 8, the pellets are pushed upwardly along the upper surface slanted at an angle α and conveyed to a methane fermentation tank 11. The acid fermentation tank 7 and the methane fermentation tank 11 are separated by a bulkhead provided with a movable valve 9 which is driven by an angle-controlling actuator 10. The methane fermentation tank 11 is provided on the upper surface thereof with a press-compacting head 12 which is intercepted from the external air by an air-tight maintaining chamber 13 where the starting pellets supplied from the acid fermentation tank 7 are compacted to eliminate air containing a trace amount of oxygen.

A residue of methane fermentation is conveyed by the aid of an upright screw conveyer 14 and a parallel screw conveyer 15 to a drying device 17 where the residue is dried with dry air blown from a blower 21 and taken out from a discharge port 23.

The biogas formed in the methane fermentation tank 11 is discharged from the exhaust opening 22.

On the other hand, a slurry product collected on the bottom surface of the methane fermentation tank 11 slanted at an angle β is recycled by the aid of a recycling pump 16 through a slurry reservoir 19 and plural spray nozzles 18 and recycled to the acid fermentation tank 7 and the methane fermentation tank 11.

The dried residue taken out from the discharge port 23 is pelletized and used as a solid fuel. A radiation thermometer 24 is used for tracing the inner temperature of the acid fermentation tank 7.

In accordance with the present invention, the biogas can effectively be generated from the biomass material in addition to a pelletized solid fuel of good quality obtained from the residue of methane fermentation.

The best mode for carrying out the present invention will now be illustrated, but the invention is not limited thereby.

### Reference Example 1

A solid matter (water content: 40% wet basis) obtained by pulverizing and dehydrating garbage was admixed with 0.01% by mass (based on dry mass) of slaked lime, and the mixture was shaped into 3 kinds of pellets each having a diameter of 7 mm and a length of 20 mm and having apparent densities of 650 kg/m³, 800 kg/m³ and 900 kg/m³.

The aforesaid pellets were supplied to a two-phase type solid-state methane fermentation apparatus system of 200-liter capacity at a feed rate of 0.5 kg/day, while a calculated amount of water was sprayed over 2 days to an acid fermentation tank leading to the open air in such a manner that the amount of water at the fifth day might become 70% wet basis. In this state, the pellets were allowed to stay for 5 days without addition of water. The amount of additional water at a methane fermentation tank was calculated and the amount of water was adjusted to become 85% wet basis. The temperature of the methane fermentation tank was continuously maintained at 25±5° C.

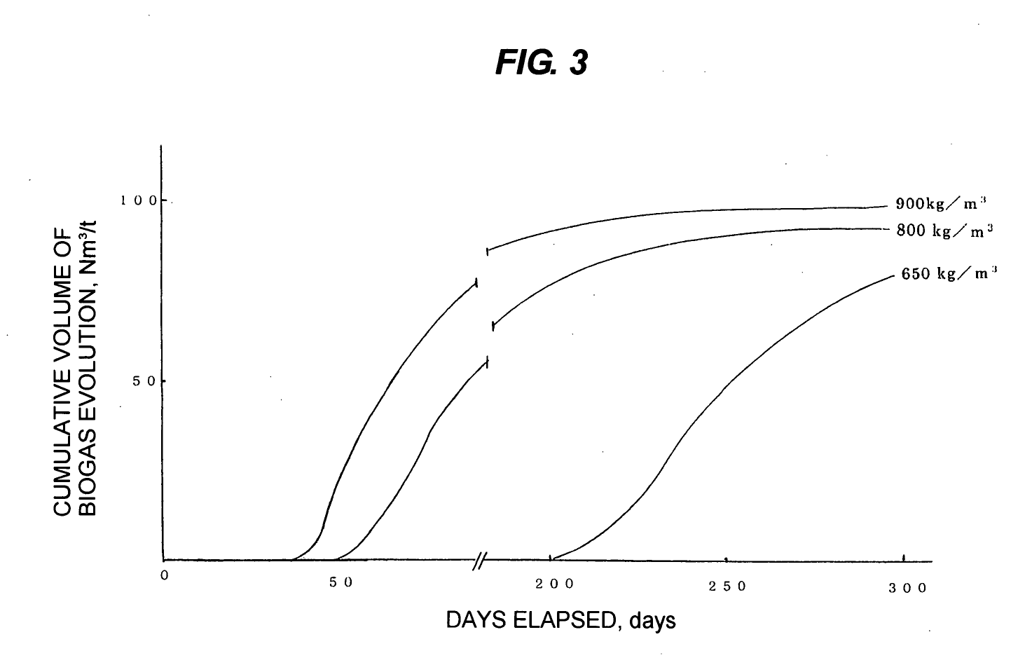

A result of the test thus obtained for the three samples is shown in FIG. 3 as a graph showing the relation in the lapse of time to the cumulative volume of biogas evolved in terms of the mass basis of the supplied garbage. By the way, the surface temperature of the pellets in the acid fermentation tank at the fifth day was measured by the radiation thermometer whereupon the temperature was 40±5° C.

### Reference Example 2

A solid matter (water content: 40% wet basis) obtained by pulverizing and dehydrating garbage was admixed with 0.01% by mass (based on dry mass) of slaked lime, and the mixture was shaped into pellets each having a diameter of 7 mm and a length of 20 mm.

The aforesaid pellets were supplied to a two-phase type solid-state methane fermentation apparatus system of 200-liter capacity at a feed rate of 0.5 kg/day, while a calculated amount of water was sprayed over 2 days to an acid fermentation tank in such a manner that the amount of water at the fifth day might become 70% wet basis. In this state, the pellets were allowed to stay for 5 days without addition of water. The amount of additional water at a methane fermentation tank was calculated and the amount of water was adjusted to become 70 to 75% wet basis. The temperature of the methane fermentation tank was continuously maintained at 25±5° C. Three samples having apparent densities of 650 kg/m³, 800 kg/m³ and 900 kg/m³ were thus prepared.

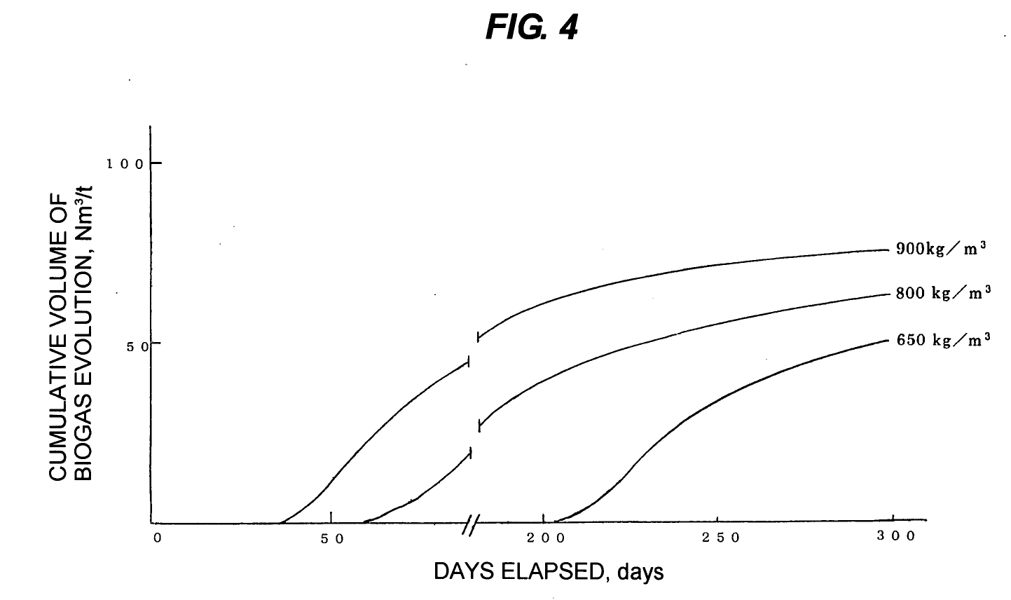

A result of the test thus obtained for the three samples is shown in FIG. 4 as a graph showing the relation in the lapse of time to the cumulative volume of biogas evolved in terms of the mass basis of the supplied garbage. By the way, the surface temperature of the pellets in the acid fermentation tank at the fifth day was measured by the radiation thermometer whereupon the temperature was 40±5° C.

### Reference Example 3

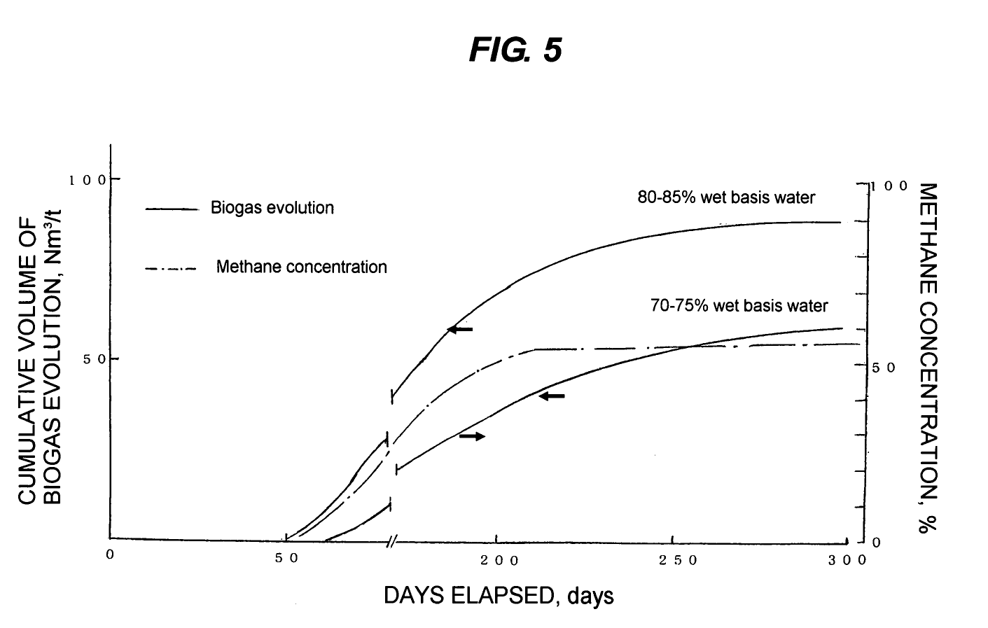

Cow dung with the exception of urine was naturally dried to prepare samples having water contents of 80 to 85% wet basis and 70 to 75% wet basis. The samples were pelletized (7 mm diameter by 15 mm) to have an apparent density of 800 kg/m³ and supplied to a two-phase type solid-state methane fermentation tank having a capacity of 1000 liters at a rate of 3.0 kg/day. FIG. 5 is a graph showing the relation between the cumulative amount of evolved biogas thus obtained and the concentration of methane.

In this Example, water was not added and the dried material was pelletized, while its water content was adjusted at the feeding pit, and fed to the acid fermentation tank and the methane fermentation tank. The movable valve provided between the acid fermentation tank and the methane fermentation tank was manually operated.

A press-compacting device and a drying device were not provided in this apparatus system. In the acid fermentation tank, the temperature of the pellets having 70 to 75% wet basis was 40 to 45° C. by controlling the oxygen concentration to 2% with PSA while the temperature of the pellets having 80 to 85% wet basis did not permit elevation of temperature at around 30° C. In both wet cases, almost no change was detected in the concentration of methane.

From the foregoing Reference Examples 1 and 2, it is noted that as the apparent density becomes greater, the concentration of methane reaches a steady state earlier. It is also noted in view of Reference Examples 1 and 2 that in case the water content is 70 to 75% wet basis, the cumulative amount of biogas evolved as well as the amount of biogas per ton of the starting material becomes lower as compared with the case of the water content being 80 to 85% wet basis.

In view of Reference Example 3, it is noted that at least 200 days are necessary for the solid material to pass through the methane fermentation tank.

### Example 1

A treatment was carried out in the same manner as described in Reference Example 1 except that prior to supplying the pellets to the methane fermentation tank in Reference Example 1, the pellets were compressed under pressure of 1.0 MPa by the aid of a press machine, whereby it was understood that the cumulative volumes of biogas evolved in each sample was increased by 20 to 30% as compared with the case of FIG. 3.

### Example 2

Garbage subjected in advance to the removal of metallic dusts by using a permanent magnet was then subjected to crushing by using a crusher to have a particle size not exceeding 10 mm. Attempted pelletization of the thus crushed material failed to pass through the die openings even under pressurization with the plastic flowability obtained at a water content of 40% wet basis or more. When the water content was decreased to around 30% wet basis by blending wood chips with the garbage, however, the material could pass through the die openings under thrusting within the elastic deformation range.

Water was sprayed to the thus obtained pellets to adjust the water content thereof to around 70% wet basis to be transferred into a two-phase solid-state methane fermentation apparatus system having a total volume of 1000 liters under a controlled oxygen concentration of around 1% for continued running to find a temperature increase of the base material up to 50° C. at the fifth day, this condition being maintained until the tenth day.

Nextly, while maintaining these conditions, an exudation liquid obtained from the bottom surface of the methane fermentation tank was sprinkled to the methane fermentation tank to keep the water content at 80% wet basis and the experiment was continued at a material temperature of 25 to 35° C. to find evolution of a biogas after lapse of 35 days, the rate of evolution reaching a stationary state after lapse of 180 days.

In the next place, the methane fermentation residue obtained here was dried in a hot-air drying oven down to a water content of 25% wet basis followed by molding into pellets by a pelletizing machine having a die opening of 7 mm so that the temperature of the pellets was increased to about 80° C. to give a solid fuel having a water content of 15 to 18% wet basis. Incidentally, the steam generated during the above mentioned drying step had a smell of ammonia but burning of the same as a biogas yielded an odorless exhaust gas.

### Example 3

The same cow dung as used in Reference Example 3 was supplied to a two-phase type solid-state methane fermentation apparatus system having the structure as shown in FIG. 2 to generate a biogas.

The resultant residue of the solid-state methane fermentation was pelletized in the same manner as in Example 1 to prepare a solid fuel comprising pellets (7 mm diameter by 20 mm) having 12% wet basis water. This solid fuel had a low-grade calorific value of about 4000 kcal/kg.

A Stirling Engine ST-5 (marketed by Stirling Engine Co., Ltd., Japan) was operated by using this fuel at a furnace temperature of 650±50° C. with a burner having a maximum output of 5000 kcal/hr whereby an electric output power of 3.0 to 3.2 kW was obtained at a fuel consumption of the methane fermentation residue pellets of 6.5 kg/per hour. Electric power conversion efficiency was about 10% while the waste heat temperature reached 450° C. It was found that the hot heat could be recovered by 50 to 60% in the event the temperature of exhaust air was decreased down to 250° C. by way of heat exchange with an air-air or water-air heat exchanger.

### Example 4

Super-heated steam obtained by high frequency heating of the solid fuel obtained by pelletizing the methane fermentation residue used in Example 3 was introduced under a pressure of 0.25 MPa into a stainless steel-made jet stream tank having a volume of 50 liters and 2 kg of pellets of the methane fermentation residue used in Example 3 were fed thereto by the aid of a screw auger while the outer wall of the jet stream tank was under heating at about 820±20° C. by the aid of a biogas burner. A thermal decomposition gas obtained as a synthesis gas after 3 minutes of the thermal decomposition was taken, which showed on assay of the gas composition to contain CO: 18%, H₂: 45%, CH₄: 9%, N₂ and O₂: 28%. On a continued running of the thermal decomposition, the concentrations of N₂ and O₂ among these gases were decreased.

What is claimed is:

1. A process for producing a biogas by solid-state fermentation of a solid biomass material which comprises the steps of:
(1) pelletizing the biomass material into pellets;
(2) introducing the pellets into an acid fermentation zone;
(3) subjecting the biomass material in the pellets to solid-state acid fermentation under facultative anaerobic conditions or under semi-aerobic conditions kept in an oxygen concentration of 0.01% to 5.0%;
(4) densifying the pellets by compression to remove the oxygen from among the particles of the biomass material;
(5) transferring the densified pellets into a methane fermentation zone; and
(6) subjecting the biomass material in the densified pellets to methane fermentation in the methane fermentation zone under anaerobic conditions.

2. The process for producing a biogas according to claim 1 wherein the biomass material pelletized in step (1) has a particle size not exceeding 100 mm.

3. The process for producing a biogas according to claim 1 wherein the pelletization of the biomass material in step (1) is conducted by extrusion of the biomass material through a die.

4. The process for producing a biogas according to claim 3 wherein the extrusion of the biomass material is carried out through a die having a diameter of 7 to 100 mm under a pressure of at least 0.5 MPa.

5. The process for producing a biogas according to claim 1 wherein the biomass material for pelletization in step (1) is blended beforehand with calcium hydroxide or calcium oxide in an amount of 0.001% to 5% by mass based on the mass of the biomass material.

6. The process for producing a biogas according to claim 1 wherein the densified pellets of the size-adjusted biomass material in step (6) have a water content of 80% to 85% by mass on the wet basis.

7. The process for producing a biogas according to claim 1 wherein the methane fermentation in step (6) is followed by recovery of the fermentation residue which is dried for use as a solid fuel.

8. The process for producing a biogas according to claim 7 wherein the solid fuel is heated with superheated steam followed by heating at 800° C. or higher to produce a thermal decomposition gas.

9. An apparatus system for producing a biogas by solid-state fermentation of a solid biomass material which comprises: an acid fermentation tank having a means for pelletization of the solid biomass material and an air inlet with a movable valve; and a methane fermentation tank having a pellet compressing means connected to the acid fermentation tank through a movable valve for separation.

10. The apparatus system according to claim 9, wherein the acid fermentation tank is provided with a feeding pit for the biomass material connected to a conveyer, an extruder having a die shaped at the tip thereof, and an upwardly slanted bottom surface connected to the extruder through the die; the methane fermentation tank being connected to the acid fermentation tank through a movable valve which is opened or closed by an angle-controlling actuator, the methane fermentation tank being provided on the upper surface thereof with a press-compacting head and a bottom surface shaped to be aslant downwardly in direction of a slurry reservoir; and a recirculation mechanism for returning a slurry collected in the slurry reservoir to the methane fermentation tank.

11. The apparatus system according to claim 9, wherein a metal-removing mechanism is further provided for a preliminary treatment of the biomass material.

12. The apparatus system according to claim 9, wherein the methane fermentation tank is provided at a discharge port of the fermentation residue with a drying oven.
